(19) United States
(12) Patent Application Publication
(10) Pub. No.: US 2026/0250897 A1
(43) Pub. Date: Aug. 27, 2026

(54) WASHING MACHINE AND METHOD FOR CONTROLLING SAME

(71) Applicant: SAMSUNG ELECTRONICS CO., LTD., Suwon-si (KR)

(72) Inventors: Hochae LEE, Suwon-si (KR); Sunghwan Hong, Suwon-si (KR)

(73) Assignee: SAMSUNG ELECTRONICS CO., LTD., Suwon-si (KR)

(21) Appl. No.: 19/648,758

(22) Filed: Apr. 15, 2026

Related U.S. Application Data
(63) Continuation of application No. PCT/KR2024/095994, filed on Aug. 9, 2024.

(30) Foreign Application Priority Data
Oct. 16, 2023 (KR) 10-2023-0138098

(51) Int. Cl. D06F 43/00; D06F 43/02; D06F 43/08

(52) U.S. Cl. CPC D06F 43/005; D06F 43/007; D06F 43/02; D06F 43/085

(57) ABSTRACT

A washing machine includes a first chamber configured to store liquid carbon dioxide; a second chamber configured to store a washing solvent; a washing chamber configured to receive at least one of the liquid carbon dioxide or the washing solvent; a sensor configured to detect contaminants on laundry in the washing chamber, and output contamination information about the detected contaminants; and a processor configured to adjust a ratio of the liquid carbon dioxide and the washing solvent to be supplied to the washing chamber based on the contamination information.

### CROSS-REFERENCE TO RELATED APPLICATIONS

This application is a bypass continuation application of International Patent Application No. PCT/KR2024/095994, filed on August 9, 2024, which claims priority to and is based on Korean Patent Application No. 10-2023-0138098, filed on October 16, 2023, the disclosures of which are incorporated herein in their entireties by reference.

### BACKGROUND

### 1. Field

The disclosure relates to a washing machine that washes the laundry using carbon dioxide, and a method for controlling the washing machine.

### 2. Description of Related Art

The washing machine using carbon dioxide may perform a cycle of external charging, supply, washing, distillation, and storage of carbon dioxide. For example, a washing machine using carbon dioxide may supply carbon dioxide in a carbon dioxide chamber to a washing chamber, perform washing by operating the washing chamber filled with carbon dioxide, discharge carbon dioxide from the washing chamber to a distillation chamber upon completion of washing, liquefy the carbon dioxide distilled in the distillation chamber, and then store the liquefied carbon dioxide in the carbon dioxide chamber.

The washing machine using carbon dioxide may only easily remove oil-soluble contaminants from laundry due to the non-polarity of carbon dioxide, but may not be able to remove water-soluble contaminants. The washing machine using carbon dioxide may exhibit poor washing performance for water-soluble contaminants.

In addition, the washing machine using carbon dioxide may adjust the pressure of the washing chamber to use carbon dioxide as a solvent in a liquid state. In this case, there might be a risk that the washing chamber may explode in the event of failure of pressure adjustment of the washing chamber.

### SUMMARY

According to an aspect of one or more embodiments of the present disclosure, a washing machine may determine a ratio of liquid carbon dioxide and a washing solvent based on a type of contaminants and a degree of contamination of laundry, and wash the laundry using a washing liquid mixed at the determined ratio.

According to an aspect of one or more embodiments of the present disclosure, a washing machine may adjust a pressure of a washing chamber based on a ratio of liquid carbon dioxide and a washing solvent.

According to an aspect of one or more embodiments of the present disclosure, a washing machine may include a first chamber configured to store liquid carbon dioxide; a second chamber configured to store a washing solvent; a washing chamber configured to receive at least one of the liquid carbon dioxide or the washing solvent; a sensor configured to detect contaminants on laundry in the washing chamber, and output contamination information about the detected contaminants; and a processor configured to adjust a ratio of the liquid carbon dioxide and the washing solvent to be supplied to the washing chamber based on the contamination information.

The washing machine may further include a mixing chamber configured to generate a washing liquid by mixing the liquid carbon dioxide and the washing solvent, the mixing chamber being connected to the first chamber, the second chamber, and the washing chamber; and a valve configured to open and close a mixed flow path between the mixing chamber and the washing chamber, the valve arranged on the mixed flow path.

The processor may be further configured to recognize a type and a degree of contamination of the contaminants based on the contamination information; and adjust the ratio of the liquid carbon dioxide and the washing solvent, based on the recognized type and the recognized degree of contamination of the contaminants.

The processor may be further configured to allow the liquid carbon dioxide and the washing solvent to be supplied to the mixing chamber based on a preset ratio; based on an elapse of a preset time, determine the ratio of the liquid carbon dioxide and the washing solvent based on the recognized type and the recognized degree of contamination of the contaminants; allow at least one of the liquid carbon dioxide or the washing solvent to be supplied to the washing chamber based on the determined ratio; and based on a subsequent elapse of the preset time, stop rotation of a drum included in the washing chamber.

The washing machine may further include a first independent flow path arranged between the first chamber and the washing chamber; and a second independent flow path arranged between the second chamber and the washing chamber. The processor may be further configured to allow at least one of the liquid carbon dioxide or the washing solvent to be supplied to the washing chamber through at least one of the first independent flow path, the second independent flow path, or the mixed flow path, based on the determined ratio.

The washing machine may further include a reserve chamber connected to the washing chamber; and a distillation chamber connected to the reserve chamber and the washing chamber. The processor may be further configured to discharge the washing liquid from the washing chamber to the reserve chamber to adjust a pressure in the washing chamber, and allow the washing liquid in the washing chamber and the washing liquid stored in the reserve chamber to be delivered to the distillation chamber based on completion of a washing process.

The washing machine may further include a heater provided in the washing chamber. The processor may be further configured to control the heater to allow a pressure in the washing chamber to be adjusted; and control the heater to dry the laundry based on completion of a washing process.

The washing machine may further include a pump configured to pump the washing liquid in the washing chamber based on completion of a washing process; and a filter configured to separate the contaminants from the washing liquid discharged from the washing chamber, the filter being connected between the washing chamber and the pump.

The washing machine may further include a distillation chamber configured to vaporize the washing liquid to separate the contaminants from the washing liquid; and a cooling chamber configured to liquefy carbon dioxide and washing solvent among the washing liquid vaporized in the distillation chamber.

The washing solvent may include at least one of a hydrocarbon-based solvent, a fluorocarbon-based solvent, or a silicon compound-based solvent.

According to an aspect of one or more embodiments of the present disclosure, a method for controlling a washing machine may include supplying the generated washing liquid to a washing chamber; rotating a drum in the washing chamber for a preset time; stopping the drum based on an elapse of the preset time; recognizing a type of contaminants based on contamination information about the contaminants on laundry in the drum; determining a ratio of the liquid carbon dioxide and the washing solvent based on the recognized type of contaminants; supplying at least one of the liquid carbon dioxide or the washing solvent to the washing chamber to adjust the preset ratio to the determined ratio; and washing the laundry by rotating the drum.

The supplying of the at least one of the liquid carbon dioxide or the washing solvent to the washing chamber may include discharging the washing liquid in the washing chamber to a reserve chamber to adjust a pressure in the washing chamber, or controlling a heater provided in the washing chamber to adjust the pressure in the washing chamber.

The method may further include discharging the washing liquid in the washing chamber and the washing liquid in the reserve chamber to a distillation chamber based on completion of a washing process; vaporizing the washing liquid through heat exchange of the washing liquid to separate the contaminants from the washing liquid; liquefying carbon dioxide and the washing solvent through heat exchange between the carbon dioxide and the washing solvent; storing the liquid carbon dioxide in the first chamber; and storing the washing solvent in the second chamber.

The method may further include recognizing a degree of contamination of the contaminants based on the contamination information; determining a number of washing processes based on the degree of contamination; and controlling the heater provided in the washing chamber to dry the laundry based on completion of a washing process.

The method may further include controlling a first valve connected to the first chamber based on the recognized type of contaminants being oil-soluble contaminants; controlling a second valve connected to the second chamber based on the recognized type of contaminants being water-soluble contaminants; and controlling the first valve and the second valve, based on the recognized type of contaminants being oil-soluble contaminants and water-soluble contaminants.

According to an aspect of one or more embodiments of the present disclosure, an apparatus may include a first chamber configured to store liquid carbon dioxide; a second chamber configured to store a washing solvent; a third chamber configured to receive at least one of the liquid carbon dioxide or the washing solvent; one or more sensors configured to detect contaminants on laundry in the third chamber; and output information about the detected contaminants; and one or more processors configured to adjust a ratio of the liquid carbon dioxide and the washing solvent to be supplied to the third chamber based on the contamination information.

The apparatus may further include a fourth chamber configured to generate a washing liquid based on mixing the liquid carbon dioxide and the washing solvent, the fourth chamber being connected to the first chamber, the second chamber, and the third chamber; and a valve configured to open and close a first flow path between the fourth chamber and the third chamber, the valve arranged on the first flow path.

The one or more processors may be further configured to recognize a type and a degree of contamination of the contaminants based on the information; and adjust the ratio of the liquid carbon dioxide and the washing solvent, based on the recognized type and the recognized degree of contamination of the contaminants.

The one or more processors may be further configured to allow the liquid carbon dioxide and the washing solvent to be supplied to the fourth chamber based on a preset ratio; based on an elapse of a preset time, determine the ratio of the liquid carbon dioxide and the washing solvent based on the recognized type and the recognized degree of contamination of the contaminants; allow at least one of the liquid carbon dioxide or the washing solvent to be supplied to the third chamber based on the determined ratio; and based on a subsequent elapse of the preset time, stop rotation of a drum inside the third chamber.

The apparatus may further include a second flow path arranged between the first chamber and the third chamber; and a third flow path arranged between the second chamber and the third chamber. The one or more processors may be further configured to allow at least one of the liquid carbon dioxide or the washing solvent to be supplied to the third chamber through at least one of the first flow path, the second flow path, or the third flow path, based on the determined ratio.

According to an aspect of one or more embodiments of the present disclosure, a washing machine may allow a user to effectively respond to various types of contaminants by dynamically adjusting a ratio of liquid carbon dioxide and a washing solvent and a pressure of a washing chamber according to a degree of contamination of laundry. One or more embodiments of the present disclosure may provide washing conditions tailored to different types of contamination by adjusting the ratio of liquid carbon dioxide and the washing solvent according to water-soluble or oil-soluble contamination.

According to one or more embodiments of the disclosure, the washing machine may improve the removal of oil-soluble contaminants and water-soluble contaminants. As such, washing efficiency may be improved.

According to one or more embodiments of the disclosure, the washing machine may reduce a driving pressure of the washing chamber by adjusting the ratio of liquid carbon dioxide and the washing solvent in consideration of a pressure change of the washing chamber, thereby saving energy of the washing machine.

According to one or more embodiments of the disclosure, the washing machine may have a safety-improved structure using liquid carbon dioxide (LCO₂), and miniaturization and weight reduction may be implemented, allowing a washing machine using liquid carbon dioxide to be used at home.

According to one or more embodiments of the disclosure, the washing machine may rotate a drum in a state where pressure equilibrium in the washing chamber and the drum is maintained, thereby stably rotating the drum during operation of the washing machine.

According to one or more embodiments of the disclosure, the washing machine may reduce the amount of carbon dioxide used in the washing machine, and thus the amount of carbon dioxide that requires to be reprocessed after washing may also be reduced. Accordingly, the time required for washing or rinsing may also be reduced.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is a diagram illustrating a configuration of a washing machine according to one or more embodiments;

FIG. 2 is an exemplary view of a washing solvent used in a washing machine according to one or more embodiments;

FIG. 3 is an exemplary view of a refrigeration cycle provided in a washing machine according to one or more embodiments;

FIG. 4 is a control block diagram of a washing machine according to one or more embodiments;

FIG. 5 illustrates a ratio of one type of washing solvent to liquid carbon dioxide used in a washing machine according to one or more embodiments, and a pressure corresponding to the ratio.

FIG. 6 illustrates a ratio of two types of washing solvents to liquid carbon dioxide used in a washing machine according to one or more embodiments, and a pressure corresponding to the ratio.

FIG. 7 is a flowchart of a washing process of a washing machine according to one or more embodiments;

FIG. 8 is a flowchart of operations of processing a washing liquid in a washing machine according to one or more embodiments; and

FIG. 9 is a diagram illustrating a configuration of a washing machine according to one or more embodiments;

### DETAILED DESCRIPTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

Further, unless stated otherwise or otherwise clear from context, phrase “based on” may refer to “based at least in part on” and not “based solely on.”

An apparatus such as washing machine according to various embodiments may perform washing, rinsing, spin-drying, and drying processes. The washing machine may be an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum and a condensing device for removing moisture from air discharged from the drum. For example, the dryer combined washing machine may include a heat pump device. The washing machine according to various embodiments may include a washing machine using a washing method other than the above-described washing method.

The washing machine according to various embodiments may include a housing accommodating various components therein. The housing may be provided in the form of a box including a laundry inlet on one side thereof.

The washing machine may include a door for opening and closing the laundry inlet. The door may be rotatably mounted to the housing by a hinge. At least a portion of the door may be transparent or translucent to allow the inside of the housing to be visible.

The washing machine may include a tub (also referred to as a washing chamber) disposed within the housing to store water or carbon dioxide. The tub may be formed in a substantially cylindrical shape with a tub opening formed on one side thereof. The tub may be disposed inside the housing in such a way that the tub opening corresponds to the laundry inlet.

The tub may be connected to the housing by a damper. The damper may absorb vibration generated when the drum rotates, and the damper may reduce vibration transmitted to the housing.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water or carbon dioxide stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include the detergent supply device configured to supply detergent to the tub. The detergent supply device may include a manual detergent supply device that requires a user to enter detergent to be used for each washing, and an automatic detergent supply device that stores a large amount of detergent and automatically adds a predetermined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the housing, a drain valve disposed on the drain pipe to open or close the drain pipe, and a pump disposed on the drain pipe. The pump may pump water from the drain pipe to the outside of the housing.

The washing machine may include a carbon dioxide chamber for storing carbon dioxide, the tub (i.e., the washing chamber) for accommodating carbon dioxide supplied from the carbon dioxide chamber, the drum provided in the tub for washing laundry, the pump for discharging carbon dioxide from the tub upon completion of washing, and a refrigeration cycle for vaporizing the discharged carbon dioxide to separate the carbon dioxide from contaminants, liquefying the vaporized carbon dioxide, and delivering the liquefied carbon dioxide to the carbon dioxide chamber.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to one or more embodiments, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

According to one or more embodiments, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, a washing machine according to various embodiments will be described in detail with reference to the accompanying drawings.

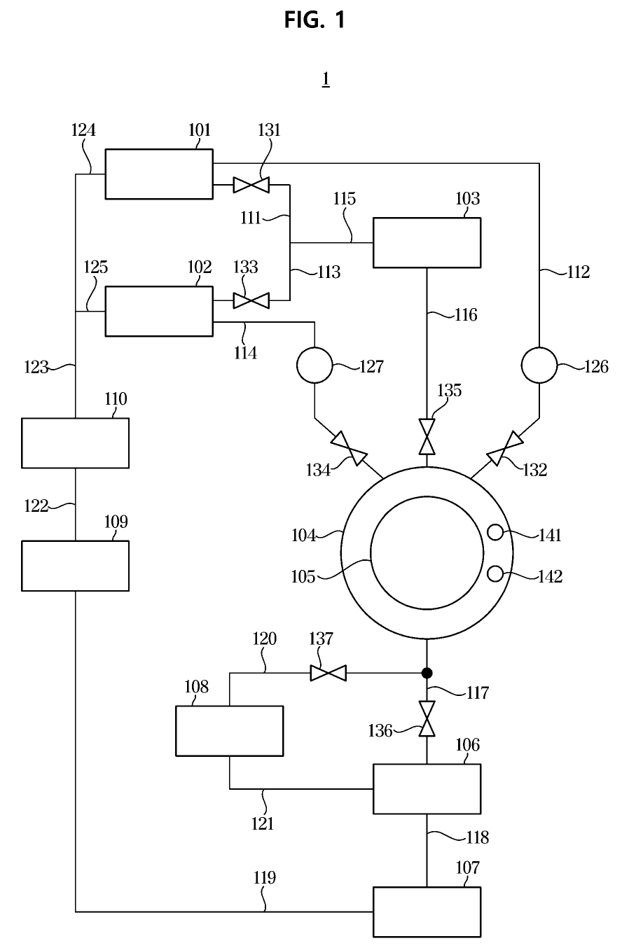

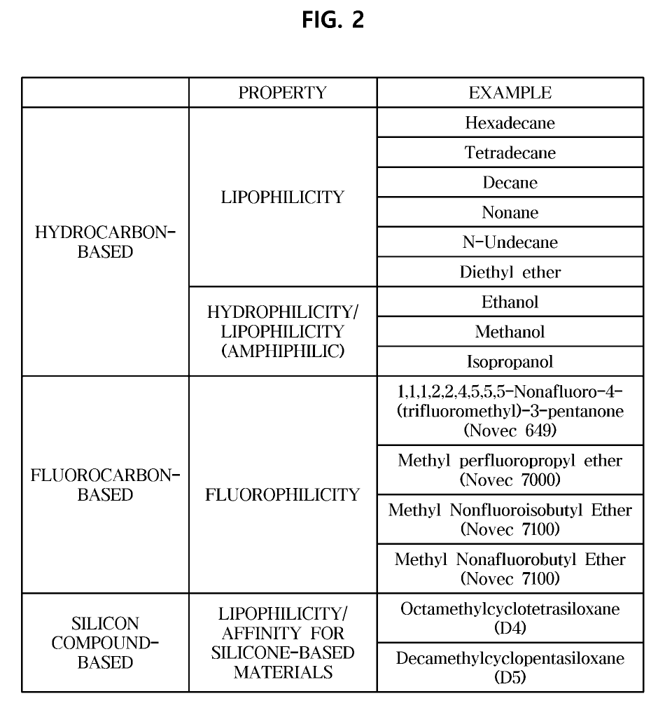

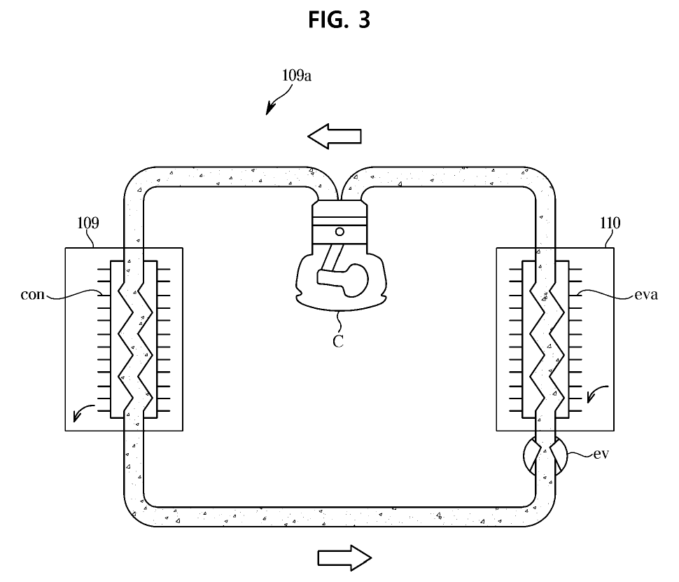

FIG. 1 is a diagram illustrating a configuration of a washing machine according to one or more embodiments, and is described with reference to FIG. 2 and FIG. 3.

FIG. 2 is an exemplary view of a washing solvent used in the washing machine according to one or more embodiments, and FIG. 3 is an exemplary view of a refrigeration cycle provided in the washing machine according to one or more embodiments.

The washing machine according to one or more embodiments may be a washing machine that washes, rinses, spin-dries, and dries laundry using liquid carbon dioxide and processes the liquid carbon dioxide.

The washing machine may include a first chamber 101, a second chamber 102, a third chamber 103, a washing chamber 104, a drum 105, a filter 106, a pump 107, a reserve chamber 108, a distillation chamber 109, and a cooling chamber 110. The washing machine may further include a plurality of flow paths 111 to 125 connected between the chambers, first and second injectors 126 and 127, and a plurality of valves 131 to 137 arranged in some of the plurality of flow paths 111 to 125 and configured to open and close some of the flow paths, respectively. In addition, the washing machine may further include a sensor 141 and a heater 142.

The first chamber 101 stores carbon dioxide. Here, the carbon dioxide may be liquid carbon dioxide (LCO₂).

The first chamber 101 may supply the liquid carbon dioxide to the washing chamber 104 or the third chamber 103.

The first chamber 101 may receive the liquid carbon dioxide delivered from the cooling chamber 110, and may store the received liquid carbon dioxide.

The liquid carbon dioxide is a solvent for washing laundry and may be a main solvent.

The first chamber 101 may maintain a pressure sufficient to store carbon dioxide in a liquid state. The pressure of the first chamber 101 may be approximately 50 bar.

The second chamber 102 may store a solvent that may be used as a laundry detergent.

The solvent that may be used as a laundry detergent is a solvent other than carbon dioxide, and may be an auxiliary solvent additionally supplied to the washing chamber to improve the washing performance of laundry.

The solvent that may be used as a laundry detergent may include a solvent having a lower vapor pressure than carbon dioxide, and may include a solvent having low reactivity with carbon dioxide or no reactivity with carbon dioxide.

The solvent that may be used as a laundry detergent may include a solvent capable of lowering the vapor pressure when mixed with carbon dioxide.

The solvent that may be used as a laundry detergent may include one type of solvent, or two or more types of solvents.

The washing solvent may be a liquid washing solvent.

The washing solvent may be a solvent including at least one characteristic among lipophilicity, hydrophilicity, fluorophilicity, or affinity for silicone-based materials.

As shown in FIG. 2, the washing solvent may include at least one of a hydrocarbon-based solvent, a fluorocarbon-based solvent, or a silicon compound-based solvent.

The hydrocarbon-based solvent may include hexadecane, tetradecane, decane, nonane, undecane, diethyl ether, methanol, and isopropanol.

The fluorocarbon-based solvent may include pentanone, methyl perfluoropropyl ether, methyl nonfluoroisobutyl ether, and methyl nonafluoro butyl ether.

The silicon compound-based solvent may include octamethylcyclotetrasiloxane and decamethylcyclopentasiloxane.

The second chamber 102 may supply the washing solvent to the washing chamber 104 or the third chamber 103.

The second chamber 102 may receive the washing solvent delivered from the cooling chamber 110, and store the received washing solvent.

The third chamber 103 may receive the liquid carbon dioxide from the first chamber 101, receive the washing solvent from the second chamber 102, and generate a mixed solvent by mixing the received liquid carbon dioxide and the received washing solvent. For example, the third chamber 103 may be a mixing chamber in which the liquid carbon dioxide and the washing solvent are mixed.

The ratio of the liquid carbon dioxide and the washing solvent received from the third chamber 103 is determined based on a pressure change due to the mixing of the liquid carbon dioxide and the washing solvent, the type of contaminants, and the degree of contamination.

The third chamber 103 may supply the mixed solvent to the washing chamber 104.

The washing chamber 104 may receive the liquid carbon dioxide from the first chamber 101, may receive the washing solvent from the second chamber 102, and may receive the mixed solvent from the third chamber 103.

During a single cycle of a washing process, the washing chamber 104 may receive the liquid carbon dioxide from the first chamber 101, receive the washing solvent from the second chamber 102, or receive the mixed solvent from the third chamber 103.

The timing of receiving the liquid carbon dioxide from the first chamber 101 may be different from that of receiving the mixed solvent from the third chamber 103.

The timing of receiving the washing solvent from the second chamber 102 may be different from that of receiving the mixed solvent from the third chamber 103.

The timing of receiving the liquid carbon dioxide from the first chamber 101 may be the same as that of receiving the washing solvent from the second chamber 102.

The washing chamber 104 may receive at least one of the liquid carbon dioxide or the washing solvent after receiving the mixed solvent.

The washing chamber 104 may additionally receive the mixed solvent after receiving the mixed solvent.

The washing chamber 104 may receive only the liquid carbon dioxide or only the washing solvent based on user input.

The mixed solvent and at least one of the liquid carbon dioxide or the washing solvent accommodated in the washing chamber 104 may be mixed with each other. Hereinafter, for convenience of description, the solvent accommodated in the washing chamber 104 will be referred to as washing liquid.

The drum 105 may be provided inside the washing chamber 104 and may be rotatable inside the washing chamber 104. The drum 105 may rotate in a clockwise direction or in a counterclockwise direction.

The drum 105 may rotate while changing its rotation speed.

The drum 105 may accommodate laundry, and may include a space where the accommodated laundry is washed.

The drum 105 may include a plurality of holes. The plurality of holes may be flow paths that allow the washing liquid accommodated in the washing chamber 104 to flow into the inside of the drum 105 and to the outside of the drum 105.

The filter 106 may be connected to the washing chamber 104, and may be a space through which the washing liquid discharged from the washing chamber 104 passes. When the washing liquid discharged from the washing chamber 104 passes through the filter 106, some of the contaminants separated from the laundry may be filtered by the filter 106. Some of the contaminants may be accommodated within the filter 106.

The filter 106 may include fine holes. One or two or more filters 106 may be provided.

The pump 107 may be connected to the washing chamber 104. The pump 107 allows the washing liquid in the washing chamber 104 to be discharged to the outside of the washing chamber 104 by pumping the washing liquid accommodated in the washing chamber 104. The washing liquid discharged from the washing chamber 104 by the pumping operation of the pump 107 may be delivered to the distillation chamber 109.

In a case where the filter 106 is provided in the washing machine, the pump 107 may be connected to the filter 106. The washing liquid discharged from the washing chamber 104 by the pumping operation of the pump 107 may be delivered to the distillation chamber 109 through the filter 106.

The reserve chamber 108 may store the washing liquid discharged from the washing chamber 104 to adjust a pressure of the washing chamber 104.

The reserve chamber 108 may be connected to the filter 106 or the distillation chamber 109.

In a case where the reserve chamber 108 is connected to the distillation chamber 109, the reserve chamber 108 may deliver the washing liquid to the distillation chamber 109.

In a case where the reserve chamber 108 is connected to the filter 106, the washing liquid discharged from the reserve chamber 108 may be delivered to the distillation chamber 109 through the filter 106. When the washing liquid discharged from the reserve chamber 108 passes through the filter 106, some of the contaminants contained in the washing liquid may be filtered by the filter 106.

The reserve chamber 108 may also be connected to the pump 107. In this case, the washing liquid stored in the reserve chamber 108 may be discharged from the reserve chamber 108 by the pumping operation of the pump 107, and may be delivered to the distillation chamber 109.

The distillation chamber 109 receives the washing liquid accommodated in the washing chamber 104 and the washing liquid stored in the reserve chamber 108, and performs distillation on the received washing liquid.

The distillation chamber 109 may receive the washing liquid pumped by the pump 107, and may receive the washing liquid filtered by the filter 106.

Contaminants may be separated from the washing liquid by the washing liquid distillation of the distillation chamber 109.

The distillation chamber 109 may convert carbon dioxide and the washing solvent into a vapor phase (phase change) using a difference in boiling points of the carbon dioxide and the washing solvent.

The carbon dioxide and the washing solvent distilled by the washing liquid distillation of the distillation chamber 109 may be delivered to the cooling chamber 110. For example, the carbon dioxide and the washing solvent distilled in the distillation chamber 109 may be carbon dioxide and washing solvent in a vaporized state.

The cooling chamber 110 may convert carbon dioxide and the washing solvent in the vaporized state into a liquefied state through heat exchange.

The cooling chamber 110 may convert carbon dioxide and the washing solvent into a liquefied state using a difference in melting points of the carbon dioxide and the washing solvent.

The carbon dioxide liquefied in the cooling chamber 110 may be delivered to the first chamber 101, and the washing solvent liquefied in the cooling chamber 110 may be delivered to the second chamber 102.

The distillation chamber 109 and the cooling chamber 110 may form a single refrigeration cycle 109a.

As shown in FIG. 3, the refrigeration cycle 109a may include a compressor C, an expansion valve ev, a condenser, and an evaporator.

In the compressor C, refrigerant vaporized in the evaporator eva is drawn in.

The compressor C compresses the drawn refrigerant and delivers the compressed refrigerant to the condenser con. The compressed refrigerant may be a gaseous refrigerant in a high-temperature and high-pressure state.

The condenser con is connected between the compressor C and the expansion valve ev, and receives the compressed refrigerant from the compressor C. The refrigerant in the condenser con may exchange heat with the washing liquid, thereby being liquefied.

The condenser con may convert the refrigerant received from the compressor C into a liquid refrigerant in a high-temperature and high-pressure state.

The condenser con delivers the liquid refrigerant in the high-temperature and high-pressure state to the expansion valve ev.

The expansion valve ev lowers the pressure of the refrigerant supplied from the condenser con through a throttling action. The expansion valve ev delivers the refrigerant with lowered pressure to the evaporator eva.

The evaporator eva converts the refrigerant received from the expansion valve ev into a gas state, and delivers the converted refrigerant to the compressor C. The refrigerant that has passed through the evaporator eva may be a gaseous refrigerant in a low-temperature and low-pressure state. The refrigerant in the evaporator eva may exchange heat with the washing liquid, thereby being vaporized. The refrigerant in the evaporator eva may evaporate while absorbing heat required for evaporation from the washing liquid.

The condenser con may be provided in the distillation chamber 109, and the evaporator eva may be provided in the cooling chamber 110.

The washing liquid in the distillation chamber 109 may be heated through heat exchange with the refrigerant in the condenser con. For example, the washing liquid in the distillation chamber 109 may be vaporized by heat released from the condenser con.

The washing liquid in the cooling chamber 110 may be cooled through heat exchange with the refrigerant in the evaporator eva, thereby being liquefied.

The washing machine may further include a contamination chamber for storing contaminants separated from the washing liquid by the washing liquid distillation in the distillation chamber 109.

The first flow path 111 may be connected to the first chamber 101, and may be a flow path through which the liquid carbon dioxide of the first chamber 101 moves.

The second flow path 112 may be arranged between the first chamber 101 and the washing chamber 104, and may be a flow path that directly supplies the liquid carbon dioxide in the first chamber 101 to the washing chamber 104.

The third flow path 113 may be connected to the second chamber 102, and may be a flow path through which the washing solvent in the second chamber 102 moves.

The fourth flow path 114 may be arranged between the second chamber 102 and the washing chamber 104, and may be a flow path that directly supplies the washing solvent in the second chamber 102 to the washing chamber 104.

The fifth flow path 115 may be connected to the first flow path 111 and the third flow path 113, and may be connected to the third chamber 103.

The fifth flow path 115 may be a connection flow path connecting the first flow path 111 and the third flow path 113.

The fifth flow path 115 receives the liquid carbon dioxide through the first flow path 111 and receives the washing solvent through the third flow path 113.

The fifth flow path 115 may deliver the liquid carbon dioxide to the third chamber 103 and deliver the washing solvent to the third chamber 103.

The sixth flow path 116 may be arranged between the third chamber 103 and the washing chamber 104.

The sixth flow path 116 may deliver the mixed solvent mixed in the third chamber 103 to the washing chamber 104. The sixth flow path 116 may be a mixed flow path through which the mixed solvent flows.

The seventh flow path 117 may be connected to the washing chamber 104.

The seventh flow path 117 may be connected to the pump 107, and may be a flow path through which the washing liquid in the washing chamber 104 pumped by the pumping operation of the pump 107 flows. The seventh flow path 117 may be a drain pipe through which the washing liquid in the washing chamber 104 is discharged.

In a case where a filter is provided in the washing machine, the seventh flow path 117 may be connected to the filter 106, and is a flow path that allows the washing liquid discharged from the washing chamber 104 by the pumping operation of the pump to be delivered to the filter 106.

The eighth flow path 118 is arranged between the filter 106 and the pump 107. The eighth flow path 118 allows the washing liquid filtered by the filter 106 to flow to the pump 107.

The ninth flow path 119 is connected between the pump 107 and the distillation chamber 109.

The ninth flow path 119 allows the washing liquid pumped by the pump 107 to flow to the distillation chamber 109.

The ninth flow path 119 allows the washing liquid stored in the reserve chamber 108 to flow to the distillation chamber 109.

The tenth flow path 120 is arranged between the washing chamber 104 and the reserve chamber 108.

The tenth flow path 120 allows the washing liquid discharged from the washing chamber 104 to flow to the reserve chamber 108.

The eleventh flow path 121 may be arranged between the reserve chamber 108 and the filter 106.

The eleventh flow path 121 allows the washing liquid discharged from the reserve chamber 108 to flow to the filter 106 so that contaminants in the washing liquid are filtered by the filter 106.

The twelfth flow path 122 may be arranged between the distillation chamber 109 and the cooling chamber 110.

The twelfth flow path 122 allows the carbon dioxide and the washing solvent vaporized in the distillation chamber 109 to flow to the cooling chamber 110.

The thirteenth flow path 123 may be connected to the cooling chamber 110.

The thirteenth flow path 123 is a flow path through which the carbon dioxide and the washing solvent liquefied in the cooling chamber 110 flow.

The fourteenth flow path 124 may be arranged between the thirteenth flow path 123 and the first chamber 101.

When the liquefied carbon dioxide (i.e., liquid carbon dioxide) is delivered from the thirteenth flow path 123, the fourteenth flow path 124 delivers the delivered liquefied carbon dioxide to the first chamber 101. Through the above, the liquid carbon dioxide used for washing may be stored in the first chamber 101 again.

The fifteenth flow path 125 may be arranged between the thirteenth flow path 123 and the second chamber 102.

When the washing solvent is delivered from the thirteenth flow path 123, the fifteenth flow path 125 delivers the delivered washing solvent to the first chamber 101. Through the above, the washing solvent used for washing may be stored in the second chamber 102 again.

The first injector 126 may be connected to the second flow path 112.

The first injector 126 may be provided in the washing chamber 104.

The first injector 126 may spray the liquid carbon dioxide moving through the second flow path 112 into the washing chamber 104.

The second injector 127 may be connected to the fourth flow path 114.

The second injector 127 may be provided in the washing chamber 104.

The second injector 127 may spray the washing solvent moving through the fourth flow path 114 into the washing chamber 104.

The first valve 131 may be provided in the first flow path 111 to open or close the first flow path 111. By opening the first valve 131, the liquid carbon dioxide may be supplied from the first chamber 101 to the third chamber 103. By closing the first valve 131, the supply of the liquid carbon dioxide from the first chamber 101 to the third chamber 103 may be blocked.

The second valve 132 may be provided in the second flow path 112 to open or close the second flow path 112. By opening the second valve 132, the liquid carbon dioxide may be supplied from the first chamber 101 to the washing chamber 104. By closing the second valve 132, the supply of the liquid carbon dioxide from the first chamber 101 to the washing chamber 104 may be blocked.

The third valve 133 may be provided in the third flow path 113 to open or close the third flow path 113. By opening the third valve 133, the washing solvent may be supplied from the second chamber 102 to the third chamber 103. By closing the third valve 133, the supply of the washing solvent from the second chamber 102 to the third chamber 103 may be blocked.

The fourth valve 134 may be provided in the fourth flow path 114 to open or close the fourth flow path 114. By opening the fourth valve 134, the washing solvent may be supplied from the second chamber 102 to the washing chamber 104. By closing the fourth valve 134, the supply of the washing solvent from the second chamber 102 to the washing chamber 104 may be blocked.

The fifth valve 135 may be provided in the sixth flow path 116 to open or close the sixth flow path 116. By opening the fifth valve 135, the mixed solvent may be supplied from the third chamber 103 to the washing chamber 104. By closing the fifth valve 135, the supply of the mixed solvent from the third chamber 103 to the washing chamber 104 may be blocked.

The sixth valve 136 may be provided in the seventh flow path 117 to open or close the seventh flow path 117. By opening the sixth valve 136, the washing liquid may be supplied from the washing chamber 104 to the filter 106. By closing the sixth valve 136, the supply of the washing liquid from the washing chamber 104 to the filter 106 may be blocked.

The seventh valve 137 may be provided in the tenth flow path 120 to open or close the tenth flow path 120. By opening the seventh valve 137, the washing liquid may be supplied from the washing chamber 104 to the reserve chamber 108. By closing the seventh valve 137, the supply of the washing liquid from the washing chamber 104 to the reserve chamber 108 may be blocked.

The sensor 141 may be provided in the washing chamber 104.

The sensor 141 may detect contaminants contained in the washing liquid in the washing chamber 104 and output contamination information corresponding to the detected contaminants. Here, the contaminants contained in the washing liquid may be contaminants separated from the laundry.

The sensor 141 may be a sensor for detecting contaminants on the laundry. The contamination information output from the sensor 141 may include information for recognizing the type of contaminants and the degree of contamination.

The sensor 141 may include at least one of an optical sensor, an ultrasonic sensor, a thermal conductivity sensor, or an image sensor.

The sensor 141 may include an oil sensor.

The sensor 141 may include a capacitance probe.

The sensor 141 may include a turbidity sensor detecting the turbidity of the washing liquid. The turbidity sensor may include an optical sensor. The turbidity of the washing liquid may correspond to the degree of contamination of the laundry.

In a case where the sensor is an optical sensor, the sensor may detect the intensity of light reflected from the washing liquid, and output a voltage corresponding to the detected intensity of light as contamination information. The intensity of the reflected light may vary depending on the type of contaminants.

In a case where the sensor is an ultrasonic sensor, the sensor may output a transmission and reception time of ultrasonic waves as contamination information.

In a case where the sensor is a thermal conductivity sensor, the sensor may output the detected thermal conductivity as contamination information.

In a case where the sensor is an image sensor, the sensor may output image information of the washing liquid containing contaminants as contamination information.

In a case where the sensor is a capacitance probe, the sensor may output a voltage corresponding to a dielectric constant as contamination information. The dielectric constant may vary depending on oil-soluble contaminants or water-soluble contaminants.

The heater 142 may be provided in the washing chamber 104.

The heater 142 may operate when a pressure of the washing chamber 104 is adjusted.

The heater 142 may operate when the laundry in the washing chamber 104 is dried.

The heater 142 may be provided in the washing chamber 104 for adjusting the pressure of the washing chamber 104 and drying the laundry.

A heater for adjusting the pressure of the washing chamber 104 and a heater for drying the laundry may be separate heaters.

One or two or more heaters may be provided in the washing chamber 104.

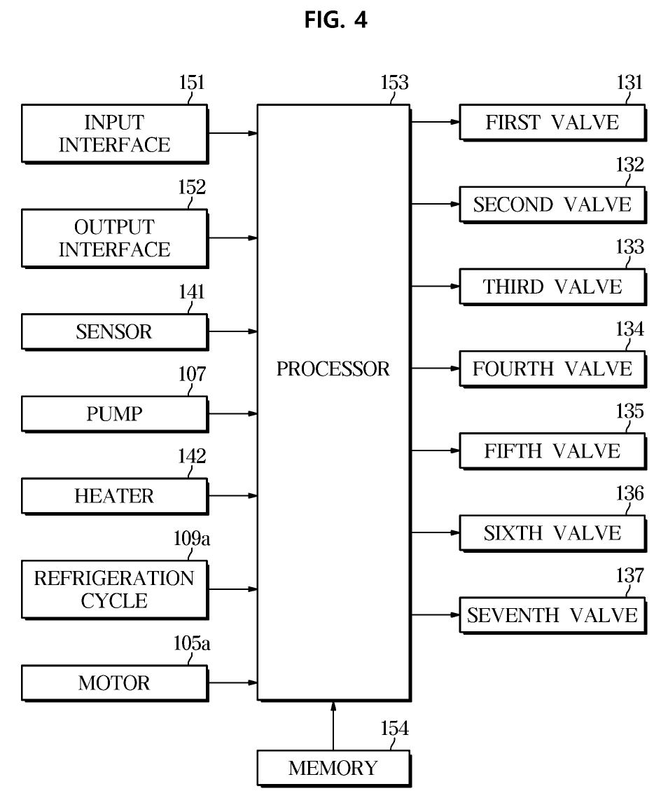

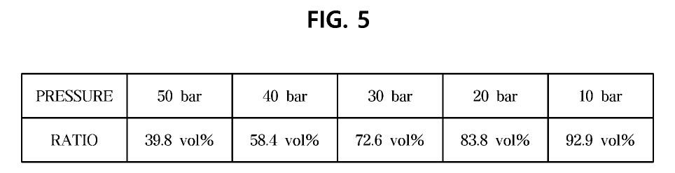

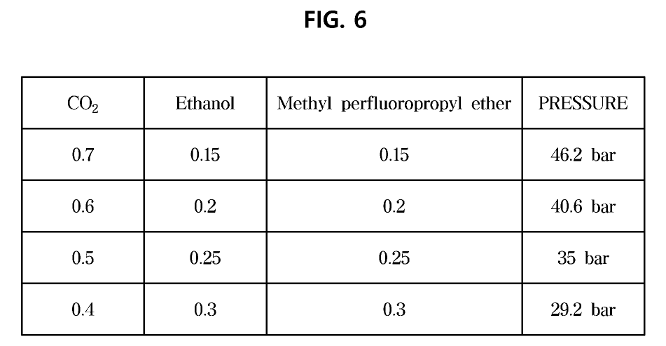

FIG. 4 is a control block diagram of a washing machine according to one or more embodiments, and is described with reference to FIG. 5 and FIG. 6.

The washing machine may include a motor 105a, the pump 107, the refrigeration cycle 109a, the plurality of valves 131 to 137, the sensor 141, the heater 142, an input interface 151, an output interface 152, a processor 153, and a memory 154.

The motor 105a may be connected to the drum 105.

The motor 105a delivers rotational force required for the rotation of the drum 105. The motor 105a may rotate in a clockwise direction or in a counterclockwise direction in response to a control command of the processor 153. The motor 105a may rotate at a speed corresponding to a control command of the processor 153.

The motor 105a may rotate or stop in response to a control command of the processor 153.

The pump 107 may perform a pumping operation in response to a control command of the processor 153. The pump 107 may include a pumping motor. In response to a control command of the processor 153, the pump 107 may rotate the pumping motor to adjust the pressure at an intake side and a discharge side, and thus a washing liquid in the washing chamber may be drawn in and then the drawn washing liquid may be discharged to the distillation chamber.

The pump 107 may rotate the pumping motor in response to a control command of the processor 153 to adjust the pressure at the intake side and the discharge side, and thus the washing liquid in the reserve chamber may be drawn in and then the drawn washing liquid may be discharged to the distillation chamber.

The refrigeration cycle 109a operates the compressor C and the expansion valve ev in response to a control command of the processor 153.

The refrigeration cycle 109a controls an operation rate of the compressor C and an opening degree of the expansion valve ev to adjust heat generation in the condenser con and heat absorption in the evaporator eva. Accordingly, the washing liquid may be vaporized in the distillation chamber 109, and may be liquefied in the cooling chamber 110.

Each of the plurality of valves 131 to 137 may be opened or closed in response to a control command of the processor 153. Each of the plurality of valves 131 to 137 may adjust its opening degree in response to a control command of the processor 153.

The sensor 141 may detect contaminants of the laundry accommodated in the drum 105, and output contamination information about the detected contaminants. The sensor 141 may detect contaminants contained in the washing liquid in the washing chamber or the drum 105, and output contamination information about the detected contaminants. The washing liquid may contain contaminants separated from the laundry.

The sensor 141 may be activated or deactivated in response to a control command of the processor 153.

The sensor 141 may output contamination information when activated in response to a control command of the processor 153.

The heater 142 may be turned on or off in response to a control command of the processor 153.

The heater 142 may adjust a heat generation amount in response to a control command of the processor 153.

The input interface 151 receives user input. The input interface 151 may be provided on a control panel.

The input interface 151 may receive a washing start command, a washing pause command, and a washing stop command.

The input interface 151 may further receive at least one of an operation time of a washing process, the number of times the washing process is performed (the number of washing processes), an operation time of a rinsing process, the number of rinsing processes, an operation time of a spin-drying process, a spin-drying level, an operation of a drying process, or a drying level.

The input interface 151 may receive a washing course. Here, the washing course may include a water-soluble contaminant washing course and an oil-soluble contaminant washing course.

The input interface 151 may include hardware devices, such as various buttons, switches, a pedal, a keyboard, a mouse, a track-ball, various levers, handles, or sticks for user input.

In addition, the input interface 151 may include a software-based device, such as a graphical user interface (GUI), for example, a touch pad. The touch pad may be implemented as a touch screen panel (TSP) to form an integrated layered structure with the output interface.

The output interface 152 may display operation information of the washing machine and user input information received through user input.

The output interface 152 may display at least one of the operation time of the washing process, the number of washing processes, the operation time of the rinsing process, the number of rinsing processes, the operation time of the spin-drying process, the spin-drying level, the operation time of the drying process, or the drying level.

The output interface 152 may display information about the remaining process.

The output interface 152 may be provided as a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, or an organic light emitting diode (OLED) panel, but is not limited thereto.

The processor 153 controls the overall operation of the washing machine 1. One or two or more processors 153 may be provided. For example, at least one processor 153 may be provided.

The processor 153 may perform the above-described operations using data (e.g., instructions) stored in the memory 154.

Based on receiving a washing start command via the input interface 151, the processor 153 may confirm a preset ratio, confirm a supply amount of liquid carbon dioxide and a supply amount of a washing solvent corresponding to the confirmed ratio, and may control the supply of the liquid carbon dioxide and the washing solvent based on the confirmed supply amount of the liquid carbon dioxide and the confirmed supply amount of the washing solvent.

The ratio (y/x) may be a ratio of the washing solvent y to the liquid carbon dioxide x.

A ratio (y:x) may also be used instead of the ratio (y/x) to supply the liquid carbon dioxide and the washing solvent.

The processor 153 may also obtain the amount of laundry accommodated in the drum using the rotation of the drum, and confirm the supply amount of the liquid carbon dioxide and the supply amount of the washing solvent corresponding to the obtained amount of laundry. In this case, the confirmed supply amount of the liquid carbon dioxide and the confirmed supply amount of the washing solvent may be amounts having a preset ratio.

The processor 153 may control the opening of the first valve 131 for the supply of the liquid carbon dioxide, and control the opening of the third valve 133 for the supply of the washing solvent.

The processor 153 may control the closing of the first valve 131 based on determining that the supply of the liquid carbon dioxide is completed, and control the closing of the third valve 133 based on determining that the supply of the washing solvent is completed.

The processor 153 may determine that the supply of the liquid carbon dioxide is completed, based on the supply time of the liquid carbon dioxide, and may determine that the supply of the washing solvent is completed, based on the supply time of the washing solvent. In this case, information about the supply amount of the liquid carbon dioxide corresponding to the supply time of the liquid carbon dioxide and the supply amount of the washing solvent corresponding to the supply time of the washing solvent may be stored in advance.

In a case where first and second flow meters are provided in the first and third flow paths of the washing machine, the processor 153 may also determine that the supply of the liquid carbon dioxide is completed based on the amount of the liquid carbon dioxide measured by the first flow meter, and may determine that the supply of the washing solvent is completed based on the amount of the washing solvent measured by the second flow meter.

The processor 153 may also control the mixing chamber for mixing the liquid carbon dioxide and the washing solvent. For example, the mixing chamber may include an agitator, and the processor 153 may control an agitating operation of the agitator.

Based on determining that the mixing of the liquid carbon dioxide and the washing solvent is completed, the processor 153 may control the opening of the fifth valve 135 so that the mixed solvent in which the liquid carbon dioxide and the washing solvent are mixed is supplied to the washing chamber 104.

The processor 153 may control the closing of the fifth valve 135 based on determining that the supply of the mixed solvent is completed.

The processor 153 may confirm a pressure corresponding to the ratio of the mixed solvent, and based on determining that the confirmed pressure is greater than or equal to a reference pressure, may control the opening of the seventh valve 137 to allow the washing liquid in the washing chamber to be discharged to the reserve chamber 108.

The processor 153 may confirm a discharge amount of the washing liquid corresponding to the confirmed pressure based on the information stored in the memory 154, and may confirm an opening time of the seventh valve 137 corresponding to the discharge amount of the washing liquid.

The processor 153 may also confirm the opening time of the seventh valve 137 corresponding to the confirmed pressure based on the information stored in the memory 154.

The processor 153 may obtain a difference value between the confirmed pressure and the reference pressure, obtain a discharge amount of the washing liquid corresponding to the obtained difference value from the information stored in the memory 154, and confirm the opening time of the seventh valve 137 corresponding to the discharge amount of the washing liquid.

The processor 153 may also confirm the opening time of the seventh valve 137 corresponding to the obtained difference value.

In a case where a pressure sensor is provided in the washing chamber, the processor 153 may also obtain a difference value between the pressure of the washing chamber detected by the pressure sensor and the reference pressure, obtain a discharge amount of the washing liquid corresponding to the obtained difference value from the information stored in the memory 154, and confirm the opening time of the seventh valve 137 corresponding to the discharge amount of the washing liquid.

When controlling the opening of the seventh valve 137, the processor 153 may count an opening time during which the seventh valve 137 is open and control the closing of the seventh valve 137 based on determining that the counted time is the confirmed opening time.

The processor 153 may also control the operation of the heater 142 to adjust the pressure of the washing chamber 104 by the supply of at least one of the liquid carbon dioxide or the washing solvent.

When controlling the heater, the processor 153 may control the heat generation amount of the heater 142 or an operation time of the heater 142.

The processor 153 may confirm a pressure corresponding to the ratio of the mixed solvent, and based on determining that the confirmed pressure is greater than or equal to the reference pressure, may control the operation of the heater 142.

The processor 153 may confirm at least one of the operation time or the heat generation amount of the heater corresponding to the confirmed pressure based on the information stored in the memory 154, and may control the operation of the heater 142 based on at least one of the confirmed operation time of the heater or the confirmed heat generation amount of the heater.

The processor 153 may obtain a difference value between the confirmed pressure and the reference pressure, may confirm at least one of the operation time or the heat generation amount of the heater corresponding to the obtained difference value based on the information stored in the memory 154, and may control the operation of the heater 142 based on at least one of the confirmed operation time of the heater or the confirmed heat generation amount of the heater.

In a case where a pressure sensor is provided in the washing chamber, the processor 153 may obtain a difference value between the pressure of the washing chamber detected by the pressure sensor and the reference pressure, may confirm at least one of the operation time or the heat generation amount of the heater corresponding to the obtained difference value based on the information stored in the memory 154, and may control the operation of the heater 142 based on at least one of the confirmed operation time of the heater or the confirmed heat generation amount of the heater.

When controlling the operation of the heater 142, the processor 153 may count an operation time during which the heater 142 is operated and control the heater 142 to be turned off based on determining that the counted time is the confirmed operation time.

In a case where a temperature sensor is provided in the washing chamber, the processor 153 may confirm a reference temperature corresponding to the ratio of the liquid carbon dioxide and the washing solvent based on the information stored in the memory 154, compare a temperature of the washing chamber detected by the temperature sensor with the reference temperature, and may control the heater 142 to be turned off in response to the temperature of the washing chamber being the reference temperature.

The reference temperature may refer to a temperature at which the pressure in the washing chamber is less than or equal to the reference pressure, and may vary depending on the ratio of the liquid carbon dioxide and the washing solvent.

The processor 153 may also control additional supply of the washing solvent to adjust the pressure of the washing chamber 104 by the supply of at least one of the liquid carbon dioxide or the washing solvent. Pressure change information corresponding to the supply amount of the washing solvent may be stored in advance.

Based on determining that the pressure of the washing chamber is adjusted to be less than or equal to the reference pressure, the processor 153 may control a primary washing during a first washing process by controlling the motor 105a to rotate the drum 105 for a preset time.

In controlling the motor 105a, the processor 153 may control the motor 105a to rotate in a clockwise direction for the preset time or to rotate in a counterclockwise direction for the preset time, and may also control the motor 105a to alternately rotate in the clockwise direction and the counterclockwise direction for the preset time.

The processor 153 may allow the primary washing to be performed for the preset time through the rotation of the drum 105.

When the preset time has elapsed, the processor 153 may control the motor 105a to stop so that the drum 105 stops.

The processor 153 may control the activation of the sensor 141, and when contamination information is received from the activated sensor 141, may recognize a type and a degree of contamination of the contaminants of the laundry based on the received contamination information.

The processor 153 may determine the ratio of the liquid carbon dioxide and the washing solvent based on the recognized type of contaminants, and adjust the preset ratio to the determined ratio.

In determining the ratio of the liquid carbon dioxide and the washing solvent, the processor 153 may determine the ratio of the liquid carbon dioxide and the washing solvent, based on the pressure corresponding to the ratio (y:x) or the ratio (y/x) of the washing solvent y to the liquid carbon dioxide x.

FIG. 5 illustrates a ratio of one type of washing solvent to liquid carbon dioxide, and a pressure corresponding to the ratio. Here, the one type of washing solvent may be methyl perfluoropropyl ethyl (Novec 7000).

As shown in FIG. 5, it may be seen that the pressure decreases as the ratio of the two types of washing solvents to the liquid carbon dioxide increases.

FIG. 6 illustrates a ratio of two types of washing solvents to liquid carbon dioxide, and a pressure corresponding to the ratio. Here, the two types of washing solvents may be ethanol and methyl perfluoropropyl ethyl.

As shown in FIG. 6, it may be seen that the pressure increases as the ratio of the liquid carbon dioxide and the two types of washing solvents increases.

When adjusting the ratio, the processor 153 may allow at least one of the liquid carbon dioxide or the washing solvent to be supplied to the washing chamber 104 based on the determined ratio, and thus the ratio of the liquid carbon dioxide and the washing solvent in the washing chamber may be adjusted to the determined ratio.

The processor 153 compares a preset ratio with the determined ratio, and based on determining that the preset ratio and the determined ratio are the same, controls a secondary washing using the washing liquid accommodated in the washing chamber 104 without additional supply of the liquid carbon dioxide and the washing solvent.

Based on determining that the preset ratio is different from the determined ratio, the processor 153 may determine a supply amount of at least one of the liquid carbon dioxide or the washing solvent based on the preset ratio and the determined ratio, and may control the supply of at least one of the liquid carbon dioxide or the washing solvent based on the supply amount of at least one of the liquid carbon dioxide or the washing solvent.

Based on determining that the preset ratio is different from the determined ratio and the preset ratio is less than the determined ratio, the processor 153 may determine that additional supply of the washing solvent is required. Based on determining that the preset ratio is greater than the determined ratio, the processor 153 may determine that additional supply of the liquid carbon dioxide is required.

For example, in a case where the preset ratio is 1/9 (=0.11) and the determined ratio is 2/8 (=0.25), the processor 153 may determine the supply amount of the washing solvent (b=a*0.14) based on the supply amount a of the liquid carbon dioxide and a ratio difference value (=0.14).

Here, the preset ratio may be the ratio of the supply amount of the washing solvent to the supply amount of the liquid carbon dioxide, and the determined ratio may be the ratio of the supply amount of the washing solvent to the supply amount of the liquid carbon dioxide.

The processor 153 may adjust the ratio of the washing solvent to the liquid carbon dioxide in the washing chamber to the determined ratio by additionally supplying the washing solvent in an amount equal to 0.14 times the supply amount of the liquid carbon dioxide.

In another example, in a case where the preset ratio is 3/7 (=0.43) and the determined ratio is 1/9 (=0.11), the processor 153 may determine the supply amount of the liquid carbon dioxide (g=f*0.32) based on the supply amount f of the washing solvent and a ratio difference value (=0.32).

The processor 153 may adjust the ratio of the washing solvent to the liquid carbon dioxide in the washing chamber to the determined ratio by additionally supplying the liquid carbon dioxide in an amount equal to 0.32 times the supply amount of the washing solvent.

When controlling the supply of at least one of the liquid carbon dioxide or the washing solvent, the processor 153 may control at least one of the opening of the second valve 132 or the opening of the fourth valve 134.

When controlling the supply of at least one of the liquid carbon dioxide or the washing solvent, the processor 153 may control the opening of the second valve 132 based on the supply amount of the liquid carbon dioxide, and control the opening of the fourth valve 134 based on the supply amount of the washing solvent.

Here, controlling the opening of the second and fourth valves 132 and 134 may include controlling an opening time of the second and fourth valves 132 and 134, or controlling an opening time and an opening degree of the second and fourth valves 132 and 134.

The processor 153 may control the closing of at least one of the second and fourth valves 132 and 134 based on determining that the supply of at least one of the liquid carbon dioxide or the washing solvent is completed.

When controlling the supply of both the liquid carbon dioxide and the washing solvent, the processor 153 may control the opening of the first valve 131 and the third valve 133 based on the supply amount of the liquid carbon dioxide. Based on determining that the supply of the liquid carbon dioxide and the washing solvent is completed, the processor 153 may control the closing of the first valve 131 and the third valve 133. Here, controlling the opening of the first, third, and fifth valves 131, 133, and 135 may include controlling an opening time of the first, third, and fifth valves 131, 133, and 135, or controlling an opening time and an opening degree of the first, third, and fifth valves 131, 133, and 135.

Based on determining that additional mixing of the liquid carbon dioxide and the washing solvent in the third chamber 103 is completed, the processor 153 may control the opening of the fifth valve 135. Based on determining that additional supply of the mixed solvent is completed, the processor 153 may control the closing of the fifth valve 135.

Based on determining that at least one of the liquid carbon dioxide or the washing solvent is supplied to the washing chamber, the processor 153 controls the secondary washing using the washing liquid accommodated in the washing chamber 104.

The washing liquid accommodated in the washing chamber 104 may include at least one of the liquid carbon dioxide and the washing solvent which are supplied at a predetermined ratio, or the additionally supplied liquid carbon dioxide and washing solvent. The washing liquid accommodated in the washing chamber 104 may differ only in the ratio of components, while its composition remains the liquid carbon dioxide and the washing solvent.

When controlling the supply of at least one of the liquid carbon dioxide or the washing solvent, the processor 153 determines whether the pressure of the washing chamber will change to be greater than or equal to the reference pressure, based on the supply amount of the liquid carbon dioxide and the supply amount of the washing solvent supplied to the washing chamber. Based on determining that the pressure of the washing chamber will change to be greater than or equal to the reference pressure, the processor 153 controls the opening of the seventh valve 137 or controls the operation of the heater 142 so that the pressure of the washing chamber 104 becomes less than the reference pressure.

When controlling the secondary washing, the processor 153 may control the motor 105a to rotate the drum 105. Controlling the motor may vary depending on the washing course by user input.

The processor 153 may control the first washing process based on a preset washing process time or a washing process time set by user input.

When the first washing process is completed, the processor 153 may control the opening of the sixth valve 136 and the operation of the pump 107 in order to move the washing liquid used in the first washing process to the distillation chamber 109. In addition, by controlling the operation of the pump, the washing liquid stored in the reserve chamber 108 may also be moved to the distillation chamber 109 through the filter 106.

Based on determining that discharge of the washing liquid is completed, the processor 153 may control the pump 107 to stop and control the closing of the sixth valve 136.

The processor 153 may control the compressor C and the expansion valve ev of the refrigeration cycle 109a so that the washing liquid is vaporized in the distillation chamber 109 and is liquefied in the cooling chamber 110. In this instance, the liquefied carbon dioxide may be stored in the first chamber 101, and the liquefied washing solvent may be stored in the second chamber 102.

When the first washing process is completed, the processor 153 may control a second washing process. The second washing process may be controlled in the same manner as the first washing process.

The processor 153 may control the washing process based on the preset number of times the washing process is performed or the number of washing processes set by user input.

The processor 153 may also determine whether to add a washing process based on the recognized degree of contamination.

For example, the processor 153 may determine that a washing process is additionally required based on the recognized degree of contamination being greater than or equal to a reference degree of contamination, and determine that the addition of washing process is not required based on the recognized degree of contamination being less than the reference degree of contamination.

The processor 153 may also determine the number of washing processes based on the degree of contamination.

Based on receiving a water-soluble contaminant washing course via the input interface 151, the processor 153 may control the opening of the fourth valve 134 to supply the washing solvent. When the supply of the washing solvent is completed, the processor 153 may control the closing of the fourth valve 134 and then control the motor 105a to allow the washing process to be performed.

Based on receiving an oil-soluble contaminant washing course via the input interface 151, the processor 153 may control the opening of the second valve 132 to supply the liquid carbon dioxide based on the received oil-soluble contaminant washing course. When the supply of the liquid carbon dioxide is completed, the processor 153 may control the closing of the second valve 132 and then control the motor 105a to allow the washing process to be performed.

The processor 153 may control rinsing, spin-drying, and drying based on preset rinsing, spin-drying, and drying processes.

The processor 153 may control rinsing, spin-drying, and drying based on a rinsing process, a spin-drying process, and a drying process which are set by user input.

The processor 153 may control rinsing, spin-drying, and drying based on a washing course set by user input.

When controlling the drying process, the processor 153 may control the operation of the heater 142. Controlling the operation of the heater 142 may include controlling at least one of the operation time of the heater or the heat generation amount of the heater.

The processor 153 may also control at least one of the operation time of the heater or the heat generation amount of the heater based on a level of the drying process.

In a case where only liquid carbon dioxide is used, a high pressure was required for liquefaction of carbon dioxide. However, in the embodiment, the pressure required to liquefy carbon dioxide may be lowered by mixing the liquid carbon dioxide and the washing solvent, and thus, the pressure of the washing chamber may also be lowered. By lowering the pressure of the washing chamber, the safety of the washing machine may be improved.

In the embodiment, not only oil-soluble contaminants but also water-soluble, fluorine-based, and silicone-based contaminants may be removed by adding polar or fluorine-based or silicone-based solvents as required.

Thus, according to the embodiment, washing power may be improved.

The memory 154 may store information about a ratio of liquid carbon dioxide and washing solvent corresponding to a type of contaminant, and information about a pressure corresponding to the ratio of the mixed solvent.

The mixed solvent may include the liquid carbon dioxide and one type of washing solvent. In this case, the memory 154 may store a ratio of the liquid carbon dioxide and the one type of washing solvent.

The mixed solvent may include the liquid carbon dioxide and two or more types of washing solvents. In this case, the memory 154 may store a ratio of the liquid carbon dioxide and the two or more types of washing solvents. For example, a ratio of liquid carbon dioxide, first washing solvent, and second washing solvent may be stored.

The memory 154 may also store information about a pressure change of the washing chamber corresponding to a supply amount of carbon dioxide, and a pressure change of the washing chamber corresponding to a supply amount of the washing solvent.

The memory 154 may store information about a ratio of the liquid carbon dioxide and the washing solvent corresponding to a degree of contamination.

The degree of contamination may be a total degree of contamination of contaminants.

The degree of contamination may include a degree of contamination for each type of contaminants.

The memory 154 may also store information about a supply amount of the liquid carbon dioxide and a supply amount of the washing solvent corresponding to the degree of contamination.

The memory 154 may also store information about a supply amount of the liquid carbon dioxide and a supply amount of the washing solvent corresponding to an amount of laundry.

The memory 154 may store a pressure of the washing chamber corresponding to a ratio of the mixed solvent, a discharge amount of the washing liquid corresponding to the pressure of the washing chamber, and an opening time of the seventh valve 137 corresponding to the discharge amount of the washing liquid.

The memory 154 may store a pressure of the washing chamber corresponding to a ratio of the mixed solvent, and an opening time of the seventh valve 137 corresponding to the pressure of the washing chamber.

The memory 154 may store a pressure of the washing chamber corresponding to a ratio of the mixed solvent, a discharge amount of the washing liquid corresponding to a difference value between the pressure of the washing chamber and the reference pressure, and an opening time of the seventh valve 137 corresponding to the difference value between the pressure of the washing chamber and the reference pressure.

The memory 154 may further store a pressure of the washing chamber corresponding to a ratio of the mixed solvent, and at least one of an operation time of the heater or a heat generation amount of the heater corresponding to the pressure of the washing chamber.

The memory 154 may further store a pressure of the washing chamber corresponding to a ratio of the mixed solvent, and at least one of an operation time of the heater or a heat generation amount of the heater corresponding to a difference value between the pressure of the washing chamber and the reference pressure.

The memory 154 may store a reference temperature corresponding to a ratio of the liquid carbon dioxide and the washing solvent. The reference temperature may be a temperature for controlling the heater to be turned off.

The memory 154 may store information about a preset ratio and a preset time for the primary washing.

The memory 154 may also store information about the reference degree of contamination for determining the completion of the washing process.

The memory 154 may store a solubility constant of a solvent corresponding to temperature and pressure changes in the washing chamber, and a solubility constant for each type of contaminants.

The memory 154 may also store information about a discharge amount of washing liquid corresponding to an excess pressure of the washing chamber. The excess pressure of the washing chamber may be a difference between an actual pressure and the reference pressure when the actual pressure of the washing chamber is higher than the reference pressure. In this case, the washing machine may further include a pressure sensor.

The memory 154 may store information about the number of washing processes, an operation time of the washing process, the number of rinsing processes, an operation time of the rinsing process, a level of spin-drying process, an operation time of the spin-drying process, a level of drying process, and an operation time of the drying process corresponding to the washing course.

The memory 154 may store data about an algorithm for controlling the operation of components in the washing machine 1 or a program reproducing the algorithm.

The memory 154 and the processor 153 may be implemented as separate chips. Alternatively, the memory 154 and the processor 153 may be implemented as a single chip.

The memory 154 may be implemented as at least one of a non-volatile memory, such as a cache, a read only memory (ROM), a programmable ROM (PROM), an erasable programmable ROM (EPROM), an electrically erasable programmable ROM (EEPROM), and a flash memory, or a volatile memory such as a random access memory (RAM), or a storage medium such as a hard disk drive (HDD) and a CD-ROM, but is not limited thereto.

The processor 153 may include multiple processors. The processor 153 may include a central processing unit (CPU).

At least one component may be added or omitted corresponding to the performance of the components of the washing machine 1 shown in FIG. 4. In addition, it will be easily understood by those skilled in the art that mutual positions of the components may be modified corresponding to the performance or structure of the washing machine.

Each component shown in FIG. 4 refers to software and/or hardware components such as a field programmable gate array (FPGA) and an application specific integrated circuit (ASIC).

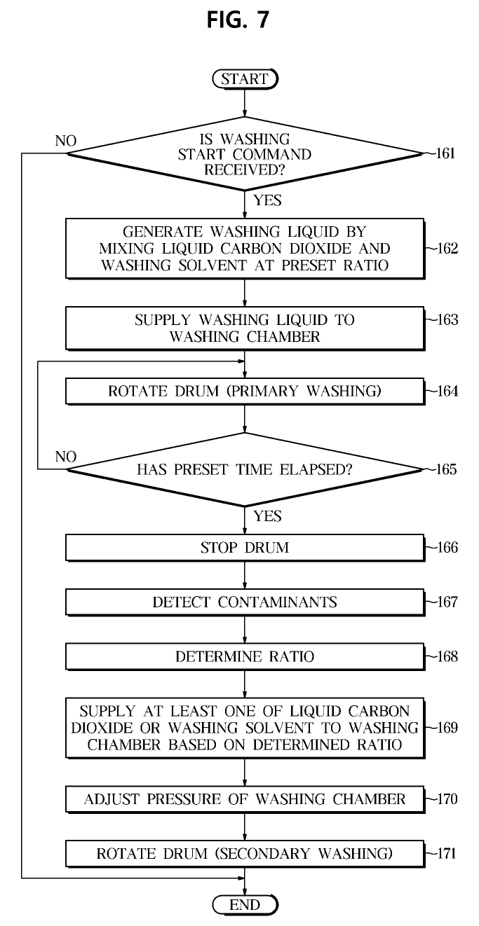

FIG. 7 is a flowchart of a washing process of the washing machine according to one or more embodiments. In the following embodiments, operations may be performed sequentially, in a different order, in parallel, or with some operations skipped or repeated.

When a washing start command is received via the input interface 151 (161), the washing machine may supply the liquid carbon dioxide in the first chamber 101 and the washing solvent in the second chamber 102 to the third chamber 103 based on a preset ratio.

When the supply of the liquid carbon dioxide and the washing solvent to the third chamber 103 is completed, the washing machine may generate a washing liquid by mixing the liquid carbon dioxide and the washing solvent (162).

More specifically, the washing machine may confirm the preset ratio stored in the memory 154, may determine the supply amount of the liquid carbon dioxide and the supply amount of the washing solvent corresponding to the confirmed ratio, and may supply the liquid carbon dioxide and the washing solvent to the third chamber 103 based on the determined supply amount of the liquid carbon dioxide and the determined supply amount of the washing solvent.

Supplying the liquid carbon dioxide and the washing solvent to the third chamber may include opening the first valve 131 to supply the liquid carbon dioxide to the third chamber, and opening the third valve 133 to supply the washing solvent to the third chamber 103.

Opening the first valve 131 may include opening the first valve 131 for an opening time of the first valve 131 corresponding to the supply amount of the liquid carbon dioxide.

Opening the third valve 133 may include opening the third valve 133 for an opening time of the third valve 133 corresponding to the supply amount of the washing solvent.

The washing machine may close the first valve 131 based on determining that the supply of the liquid carbon dioxide is completed, and close the third valve 133 based on determining that the supply of the washing solvent is completed.

The washing machine may also obtain the amount of laundry accommodated in the drum 105 using the rotation of the drum 105, or obtain the amount of laundry received via the input interface 151, and may determine the supply amount of the liquid carbon dioxide and the supply amount of the washing solvent based on the obtained amount of laundry and the preset ratio.

Based on determining that the mixing of the liquid carbon dioxide and the washing solvent is completed, the washing machine may supply the washing liquid in the third chamber 103 to the washing chamber 104 (163). The washing machine may open the fifth valve 135 to supply the washing liquid to the washing chamber. Based on determining that the supply of the washing liquid is completed, the washing machine may close the fifth valve 135.

When the supply of the washing liquid is completed, the washing machine may perform a primary washing by rotating the drum 105 for a preset time (164).

Rotating the drum may include controlling the motor 105a.

The washing machine may stop the drum 105 (166), in response to an elapse of the preset time (165).

Stopping the drum may include stopping the motor 105a.

When the drum is stopped, the washing machine may detect contamination of the washing liquid using the sensor 141 (167). The contamination of the washing liquid may include contaminants on the laundry.

Based on receiving contamination information from the sensor 141, the washing machine may recognize a type and degree of contamination of the contaminants on the laundry based on the received contamination information.

The washing machine may determine a ratio of the liquid carbon dioxide and the washing solvent based on at least one of the recognized type of contaminants or the recognized degree of contamination (168), and adjusts the preset ratio to the determined ratio.

The washing machine may supply at least one of the liquid carbon dioxide or the washing solvent to the washing chamber 104 based on the determined ratio (169). Through the above, the ratio of the liquid carbon dioxide and the washing solvent in the washing chamber is adjusted to the determined ratio.

More specifically, the washing machine may compare the preset ratio with the determined ratio. Based on determining that the preset ratio is different from the determined ratio, the washing machine may determine a supply amount of at least one of the liquid carbon dioxide or the washing solvent based on the preset ratio and the determined ratio, and may control the supply of at least one of the liquid carbon dioxide or the washing solvent based on the supply amount of at least one of the liquid carbon dioxide or the washing solvent.

Controlling the supply of at least one of the liquid carbon dioxide or the washing solvent may include opening at least one of the second valve 132 or the fourth valve 134.

Here, controlling the opening of the second and fourth valves 132 and 134 may include controlling an opening time of the second and fourth valves 132 and 134, or controlling an opening time and an opening degree of the second and fourth valves 132 and 134.

The washing machine may close at least one of the second and fourth valves 132 and 134 based on determining that the supply of at least one of the liquid carbon dioxide or the washing solvent is completed.

When supplying both the liquid carbon dioxide and the washing solvent, the washing machine may control the opening of the first valve 131 and the third valve 133 based on the supply amount of the liquid carbon dioxide. Based on determining that the supply of the liquid carbon dioxide and the washing solvent is completed, the washing machine may control the closing of the first valve 131 and the third valve 133.

Here, controlling the opening of the first, third, and fifth valves 131, 133, and 135 may include controlling an opening time of the first, third, and fifth valves 131, 133, and 135, or controlling an opening time and an opening degree of the first, third, and fifth valves 131, 133, and 135.

Based on determining that additional mixing of the liquid carbon dioxide and the washing solvent in the third chamber 103 is completed, the washing machine may control the opening of the fifth valve 135. Based on determining that additional supply of the mixed solvent is completed, the washing machine may control the closing of the fifth valve 135.

When supplying at least one of the liquid carbon dioxide or the washing solvent to the washing chamber, the washing machine may adjust a pressure of the washing chamber (170).

More specifically, when controlling the supply of at least one of the liquid carbon dioxide or the washing solvent, the washing machine may determine whether the pressure of the washing chamber will change to be greater than or equal to a reference pressure based on the supply amount of the liquid carbon dioxide and the supply amount of the washing solvent supplied to the washing chamber. Based on determining that the pressure of the washing chamber will change to be greater than or equal to the reference pressure, the washing machine may control the opening of the seventh valve 137 or control the operation of the heater 142 so that the pressure of the washing chamber 104 becomes less than the reference pressure.

Determining whether the pressure of the washing chamber will change to be greater than or equal to the reference pressure may include confirming the pressure corresponding to the determined ratio, and based on determining that the confirmed pressure is greater than or equal to the reference pressure, determining that the pressure of the washing chamber will change to be greater than or equal to the reference pressure.

In a case where a pressure sensor is provided in the washing chamber, the washing machine may compare the pressure of the washing chamber detected by the pressure sensor with the reference pressure, and based on the pressure of the washing chamber being greater than or equal to the reference pressure, may control the opening of the seventh valve 137 or control the operation of the heater 142.

When controlling the supply of at least one of the liquid carbon dioxide or the washing solvent, the washing machine may determine whether the pressure of the washing chamber will change to be greater than or equal to the reference pressure based on the supply amount of the liquid carbon dioxide and the supply amount of the washing solvent supplied to the washing chamber, and based on determining that the pressure of the washing chamber will change to be greater than or equal to the reference pressure, may also control additional supply of the washing solvent. The washing solvent may refer to a solvent capable of lowering a vapor pressure when mixed with liquid carbon dioxide.

Based on determining that the pressure adjustment is completed, the washing machine may rotate the drum and control a secondary washing using the washing liquid accommodated in the washing chamber 104 (171). In this case, the washing liquid accommodated in the washing chamber 104 may include at least one of the liquid carbon dioxide and the washing solvent which are supplied at a predetermined ratio, or the additionally supplied liquid carbon dioxide and washing solvent. The washing liquid accommodated in the washing chamber 104 may differ only in the ratio of components, while its composition remains the liquid carbon dioxide and the washing solvent.

The washing machine may compare the preset ratio with the determined ratio, and based on determining that the preset ratio and the determined ratio are the same, may control the secondary washing using the washing liquid accommodated in the washing chamber 104 without additional supply of the liquid carbon dioxide and the washing solvent.

When controlling the secondary washing, the washing machine may control the motor 105a to rotate the drum 105. Controlling the motor may vary depending on the washing course by user input.

The washing machine may control the washing process based on a preset washing process time or a washing process time set by user input.

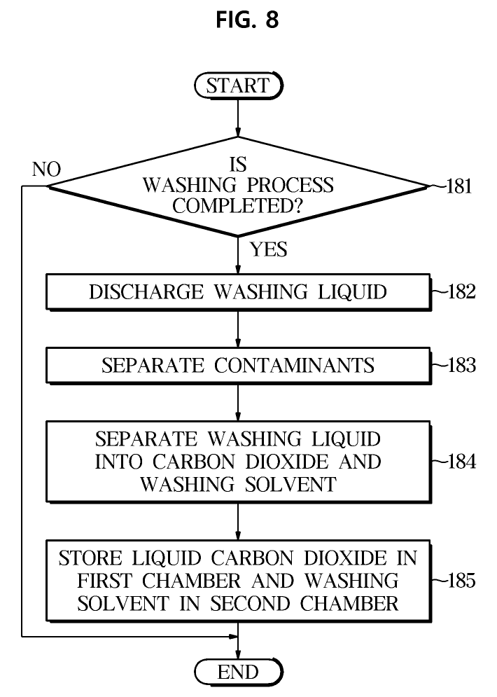

FIG. 8 is a flowchart of operations of processing a washing liquid in the washing machine according to one or more embodiments. In the following embodiments, operations may be performed sequentially, in a different order, in parallel, or with some operations skipped or repeated.

Based on determining that a washing process is completed (181), the washing machine may discharge the washing liquid used in the washing process (182).

Discharging the washing liquid may include controlling the opening of the sixth valve 136 and controlling the operation of the pump 107 to move the washing liquid in the washing chamber to the distillation chamber 109. In this instance, by controlling the operation of the pump 107, the washing liquid stored in the reserve chamber 108 may also be moved to the distillation chamber 109 through the filter 106.

Based on determining that the discharge of the washing liquid is completed, the washing machine may control the pump 107 to stop and control the closing of the sixth valve 136.

The washing machine may control the compressor C and the expansion valve ev of the refrigeration cycle 109a to allow the washing liquid to be vaporized in the distillation chamber 109, thereby separating contaminants from the washing liquid (183).

The washing liquid vaporized in the distillation chamber may be moved to the cooling chamber 110.

The washing machine may allow the washing liquid to be separated into carbon dioxide and a washing solvent by liquefying the washing liquid in the cooling chamber 110 (184). In this instance, the liquefied carbon dioxide may be stored in the first chamber 101, and the liquefied washing solvent may be stored in the second chamber 102 (185).

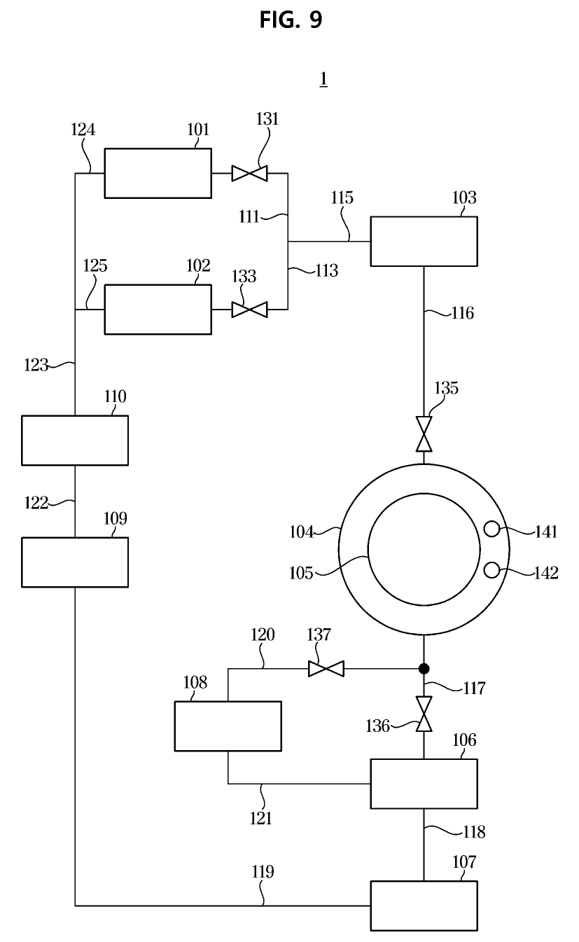

FIG. 9 is a diagram illustrating a configuration of a washing machine according to another embodiment.

In the washing machine according to another embodiment, the second flow path, the second valve, and the first injector arranged between the first chamber 101 and the washing chamber 104, and the fourth flow path, the fourth valve, and the second injector arranged between the second chamber 102 and the washing chamber 104 may be omitted.

In a secondary washing, when additionally supplying at least one of the liquid carbon dioxide or the washing solvent to the washing chamber based on contamination information, the washing machine according to another embodiment may supply at least one of the liquid carbon dioxide or the washing solvent to the washing chamber through the third chamber.

More specifically, when a washing start command is received via the input interface 151, the washing machine according to another embodiment may confirm a preset ratio, confirm a supply amount of liquid carbon dioxide and a supply amount of a washing solvent corresponding to the confirmed ratio, and may control the supply of the liquid carbon dioxide and the washing solvent based on the confirmed supply amount of the liquid carbon dioxide and the confirmed supply amount of the washing solvent.

The washing machine may control the opening of the first valve 131 to supply the liquid carbon dioxide, and control the opening of the third valve 133 to supply the washing solvent.

The washing machine may control the closing of the first valve 131 based on determining that the supply of the liquid carbon dioxide is completed, and control the closing of the third valve 133 based on determining that the supply of the washing solvent is completed.

Based on determining that mixing of the liquid carbon dioxide and the washing solvent is completed, the washing machine may control the opening of the fifth valve 135 so that the mixed solvent in which the liquid carbon dioxide and the washing solvent are mixed is supplied to the washing chamber 104.

The washing machine may control the closing of the fifth valve 135 based on determining that the supply of the mixed solvent is completed.

The washing machine may control the motor 105a to stop in order to stop the drum 105 in response to an elapse of a preset time.

The washing machine may control the activation of the sensor 141, and when contamination information is received from the activated sensor 141, may recognize a type and a degree of contamination of the contaminants of the laundry based on the received contamination information.

The washing machine may determine a ratio of the liquid carbon dioxide and the washing solvent based on the recognized type of contaminants, and adjust the preset ratio to the determined ratio.

When adjusting the ratio, the washing machine may supply at least one of the liquid carbon dioxide or the washing solvent to the washing chamber 104 based on the determined ratio, and thus the ratio of the liquid carbon dioxide and the washing solvent in the washing chamber may be adjusted to the determined ratio.

The washing machine may determine the supply amount of at least one of the liquid carbon dioxide or the washing solvent based on the preset ratio and the determined ratio, and may control the supply of at least one of the liquid carbon dioxide or the washing solvent based on the supply amount of at least one of the liquid carbon dioxide or the washing solvent.

When controlling the supply of at least one of the liquid carbon dioxide or the washing solvent, the washing machine may control the opening of at least one of the first valve 131 or the second valve 132, and control the opening of the fifth valve 135.

When controlling the supply of at least one of the liquid carbon dioxide or the washing solvent, the washing machine may control the opening of the first valve 131 and the fifth valve 135 based on the supply amount of the liquid carbon dioxide, and control the opening of the third valve 133 and the fifth valve 135 based on the supply amount of the washing solvent.

Here, controlling the opening of the first and third valves 131 and 133 may include controlling an opening time of the first and third valves 131 and 133, or controlling an opening time and an opening degree of the first and third valves 131 and 133.

The washing machine may control the closing of the fifth valve based on determining that the supply of at least one of the liquid carbon dioxide or the washing solvent is completed, and control the closing of at least one of the first and third valves 131 and 133.

Controlling the closing of at least one of the first and third valves 131 and 133 may include controlling the closing of the opened valve.

When supplying only the liquid carbon dioxide to the washing chamber, the washing machine may allow the liquid carbon dioxide to be supplied to the washing chamber through the third chamber, and when supplying only the washing solvent to the washing chamber, the washing machine may allow the washing solvent to be supplied to the washing chamber through the third chamber.

When at least one of the liquid carbon dioxide or the washing solvent is supplied to the washing chamber by controlling the opening of the fifth valve 135, the washing machine may also adjust a pressure of the washing chamber. Because the pressure adjustment of the washing chamber is performed in the same manner as that of one or more embodiments described above, the description thereof is omitted.

When the pressure adjustment is completed, the washing machine may rotate the drum to perform the secondary washing.

The disclosed embodiments may be implemented in the form of a recording medium that stores instructions executable by a computer. The instructions may be stored in the form of program codes, and when executed by a processor, the instructions may create a program module to perform operations of the disclosed embodiments. The recording medium may be implemented as a computer-readable recording medium.

The computer-readable recording medium may include all kinds of recording media storing instructions that can be interpreted by a computer. For example, the computer-readable recording medium may be read only memory (ROM), random access memory (RAM), a magnetic tape, a magnetic disc, a flash memory, an optical data storage device, etc.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

What is claimed is:

1. A washing machine comprising:
a first chamber configured to store liquid carbon dioxide;
a second chamber configured to store a washing solvent;
a washing chamber configured to receive at least one of the liquid carbon dioxide or the washing solvent;
a sensor configured to:
detect contaminants on laundry in the washing chamber; and
output contamination information about the detected contaminants; and
a processor configured to adjust a ratio of the liquid carbon dioxide and the washing solvent to be supplied to the washing chamber based on the contamination information.

2. The washing machine of claim 1, further comprising:
a mixing chamber configured to generate a washing liquid by mixing the liquid carbon dioxide and the washing solvent, the mixing chamber being connected to the first chamber, the second chamber, and the washing chamber; and
a valve configured to open and close a mixed flow path between the mixing chamber and the washing chamber, the valve arranged on the mixed flow path;

3. The washing machine of claim 2, wherein the processor is further configured to:
recognize a type and a degree of contamination of the contaminants based on the contamination information; and
adjust the ratio of the liquid carbon dioxide and the washing solvent, based on the recognized type and the recognized degree of contamination of the contaminants.

4. The washing machine of claim 3, wherein the processor is further configured to:
allow the liquid carbon dioxide and the washing solvent to be supplied to the mixing chamber based on a preset ratio;
based on an elapse of a preset time, determine the ratio of the liquid carbon dioxide and the washing solvent based on the recognized type and the recognized degree of contamination of the contaminants;
allow at least one of the liquid carbon dioxide or the washing solvent to be supplied to the washing chamber based on the determined ratio; and
based on a subsequent elapse of the preset time, stop rotation of a drum included in the washing chamber.

5. The washing machine of claim 4, further comprising:
a first independent flow path arranged between the first chamber and the washing chamber; and
a second independent flow path arranged between the second chamber and the washing chamber,
wherein the processor is further configured to allow at least one of the liquid carbon dioxide or the washing solvent to be supplied to the washing chamber through at least one of the first independent flow path, the second independent flow path, or the mixed flow path, based on the determined ratio.

6. The washing machine of claim 4, further comprising:
a reserve chamber connected to the washing chamber; and
a distillation chamber connected to the reserve chamber and the washing chamber,
wherein the processor is further configured to:
discharge the washing liquid from the washing chamber to the reserve chamber to adjust a pressure in the washing chamber; and
allow the washing liquid in the washing chamber and the washing liquid stored in the reserve chamber to be delivered to the distillation chamber based on completion of a washing process.

7. The washing machine of claim 4, further comprising:
a heater provided in the washing chamber,
wherein the processor is further configured to:
control the heater to allow a pressure in the washing chamber to be adjusted; and
control the heater to dry the laundry based on completion of a washing process.

8. The washing machine of claim 2, further comprising:
a pump configured to pump the washing liquid in the washing chamber based on completion of a washing process; and
a filter configured to separate the contaminants from the washing liquid discharged from the washing chamber, the filter being connected between the washing chamber and the pump.

9. The washing machine of claim 2, further comprising:
a distillation chamber configured to vaporize the washing liquid to separate the contaminants from the washing liquid; and
a cooling chamber configured to liquefy carbon dioxide and washing solvent among the washing liquid vaporized in the distillation chamber.

10. The washing machine of claim 1, wherein the washing solvent includes at least one of a hydrocarbon-based solvent, a fluorocarbon-based solvent, or a silicon compound-based solvent.

11. A method for controlling a washing machine, the method comprising:
generating a washing liquid by mixing liquid carbon dioxide in a first chamber and a washing solvent in a second chamber based on a preset ratio;
supplying the generated washing liquid to a washing chamber;
rotating a drum in the washing chamber for a preset time;
stopping the drum based on an elapse of the preset time;
recognizing a type of contaminants based on contamination information about the contaminants on laundry in the drum;
determining a ratio of the liquid carbon dioxide and the washing solvent based on the recognized type of contaminants;
supplying at least one of the liquid carbon dioxide or the washing solvent to the washing chamber to adjust the preset ratio to the determined ratio; and
washing the laundry by rotating the drum.

12. The method of claim 11, wherein the supplying of the at least one of the liquid carbon dioxide or the washing solvent to the washing chamber comprises:
discharging the washing liquid in the washing chamber to a reserve chamber to adjust a pressure in the washing chamber, or
controlling a heater provided in the washing chamber to adjust the pressure in the washing chamber.

13. The method of claim 12, further comprising:
discharging the washing liquid in the washing chamber and the washing liquid in the reserve chamber to a distillation chamber based on completion of a washing process;
vaporizing the washing liquid through heat exchange of the washing liquid to separate the contaminants from the washing liquid;
liquefying carbon dioxide and the washing solvent through heat exchange between the carbon dioxide and the washing solvent;
storing the liquefied carbon dioxide in the first chamber; and
storing the liquefied washing solvent in the second chamber.

14. The method of claim 12, further comprising:
recognizing a degree of contamination of the contaminants based on the contamination information;
determining a number of washing processes based on the degree of contamination; and
controlling the heater provided in the washing chamber to dry the laundry based on completion of a washing process.

15. The method of claim 12, further comprising:
controlling a first valve connected to the first chamber based on the recognized type of contaminants being oil-soluble contaminants;
controlling a second valve connected to the second chamber based on the recognized type of contaminants being water-soluble contaminants; and
controlling the first valve and the second valve, based on the recognized type of contaminants being oil-soluble contaminants and water-soluble contaminants.

16. An apparatus comprising:
a first chamber configured to store liquid carbon dioxide;
a second chamber configured to store a washing solvent;
a third chamber configured to receive at least one of the liquid carbon dioxide or the washing solvent;
one or more sensors configured to:
detect contaminants on laundry in the third chamber; and
output information about the detected contaminants; and
one or more processors configured to adjust a ratio of the liquid carbon dioxide and the washing solvent to be supplied to the third chamber based on the information.

17. The apparatus of claim 16, further comprising:
a fourth chamber configured to generate a washing liquid based on mixing the liquid carbon dioxide and the washing solvent, the fourth chamber being connected to the first chamber, the second chamber, and the third chamber; and
a valve configured to open and close a first flow path between the fourth chamber and the third chamber, the valve arranged on the first flow path.

18. The apparatus of claim 17, wherein the one or more processors are further configured to:
recognize a type and a degree of contamination of the contaminants based on the information; and
adjust the ratio of the liquid carbon dioxide and the washing solvent, based on the recognized type and the recognized degree of contamination of the contaminants.

19. The apparatus of claim 18, wherein the one or more processors are further configured to:
allow the liquid carbon dioxide and the washing solvent to be supplied to the fourth chamber based on a preset ratio;
based on an elapse of a preset time, determine the ratio of the liquid carbon dioxide and the washing solvent based on the recognized type and the recognized degree of contamination of the contaminants;
allow at least one of the liquid carbon dioxide or the washing solvent to be supplied to the third chamber based on the determined ratio; and
based on a subsequent elapse of the preset time, stop rotation of a drum inside the third chamber.

20. The apparatus of claim 19, further comprising:
a second flow path arranged between the first chamber and the third chamber; and
a third flow path arranged between the second chamber and the third chamber,
wherein the one or more processors are further configured to allow at least one of the liquid carbon dioxide or the washing solvent to be supplied to the third chamber through at least one of the first flow path, the second flow path, or the third flow path, based on the determined ratio.
